(19) United States
(12) Patent Application Publication
(10) Pub. No.: US 2016/0025438 A1
(43) Pub. Date: Jan. 28, 2016

(54) Global Positioning System Enabled and Disabled Firearm

(71) Applicant: Robert Joe Alderman, Poteet, TX (US)

(72) Inventor: Robert Joe Alderman, Poteet, TX (US)

(21) Appl. No.: 14/800,894

(22) Filed: Jul. 16, 2015

Related U.S. Application Data
(63) Continuation-in-part of application No. 14/658,384, filed on Mar. 16, 2015.
(60) Provisional application No. 62/178,823, filed on Apr. 21, 2015.
(60) Provisional application No. 61/967,364, filed on Mar. 18, 2014.

(51) Int. Cl. F41A 17/06; G01S 19/14

(52) U.S. Cl. CPC F41A 17/06; G01S 19/14; F41A 17/063

(57) ABSTRACT

A control system to enable or disable a firearm based on information from a remote location. The information may be global positioning system (GPS) information compared against a database of pre-stored forbidden location information. Thus, when the firearm is at a forbidden location matching the GPS information, it may be automatically disarmed. Similarly, the information may constitute command instructions for enabling or disabling of the firearm. Further, such command instructions may be based on information related to the firearm that is obtained from a transmitter of the firearm itself.

### PRIORITY CLAIM/CROSS REFERENCE TO RELATED APPLICATION(S)

This Patent Document claims priority under 35 U.S.C. §119 to U.S. Provisional App. Ser. No. 62/178,823, filed Apr. 21, 2015, and entitled, “GPS Gun Control”, and under 35 U.S.C. §120 to U.S. application Ser. No. 14/658,384, filed Mar. 16, 2015, and entitled, “Trigger Assist Module for a Non-Fully Automatic Firearm”, each of which is incorporated herein by reference in their entireties.

### BACKGROUND

Firearms, or portable guns that may be carried, generally by a single individual, have been available for several centuries. Views on firearms vary from country to country, jurisdiction to jurisdiction and even from person to person. Indeed, in the United States the right to “bear arms” is considered fundamental. Yet, depending on the individual, this right may be viewed as requiring strict limitations or alternatively may be viewed as requiring the broadest possible interpretations, for example of what constitutes “arms”.

Efforts to severely limit or expand firearm use have been undertaken by various governments. For example, in Switzerland firearms are actually issued by the government to individuals for personal in-home maintenance. On the other hand, in England and Australia, the ownership of firearms is so tightly regulated that the vast majority of both populations own no firearms. In an even more extreme example, the 1938 German Weapons Act went so far as to outlaw gun use entirely for Jewish people.

In spite of these varying extremes, today there are also many grounds of consensus on the topic of firearms. For example, while some particular measures are vigorously debated, the need for some level of gun safety is generally accepted across the board. So, for example, firearms generally include features to prevent accidental firing, such as a “safety” switch. Gun safety measures may be taken much further. For example, with or without specific legislation, manufacturers and users will often utilize trigger locks, gun safes and other measures aimed at preventing accidental firing or use by someone that is unauthorized.

Unfortunately, when it comes to unauthorized use, however, there is currently no full-proof manner of preventing an unauthorized user from gaining access to a functional firearm. For example, a child, a criminal or someone of compromised or impaired faculties may still be able to defeat a trigger lock or break into a gun safe. Indeed, a characteristic of every lock is that it may be unlocked at some point.

In addition to the natural limitations on the effectiveness of trigger locks and gun safes, there is also concern over how to determine who is or isn't an authorized user. For example, the safety measure of prohibiting gun ownership or use by a mentally deranged person might be widely agreed upon. However, as a practical matter, implementing this type of prohibition faces two large obstacles. First, the individual must be determined to be mentally deranged. Second, even once this determination is made, there is currently no practical full-proof way to prevent this person from gaining access to a firearm, no matter what determination has been made.

Another area in which there may be some consensus on the topic of firearms is that of firearm monitoring. For example, firearms are generally registered and equipped with serial numbers. Thus, if used for an illegal purpose and discovered, the firearm may be traced to the registered owner. Therefore, even if the registered owner is not the perpetrator of the illegal activity, authorities are nevertheless provided with some valuable insight for their investigation.

Unfortunately, while there may be general agreement on gun monitoring or tracking, this may only be of value in limited circumstances. That is, the firearm needs to be identified in order to be tracked. Once more, the only manner of identifying the firearm is to find it after the illegal activity has taken place.

As indicated above, in spite of dramatically opposing views that exist regarding firearms there are still many areas of general consensus. Specifically, gun safety in terms of preventing accidental firing, physical security, preventing unauthorized use and tracking are areas for which even those of widely different firearm viewpoints generally agree. As a practical matter, however, there is presently no full-proof manner of ensuring that any of these measures are fully effective.

### SUMMARY

A firearm is provided that includes an actuating assembly that coordinates the firing of a given round from the firearm. The firearm includes an implement for interfacing a component of the assembly so as to disable or enable the firing of the round. A processor of the firearm is coupled to a motor thereof for controlling the interfacing between the implement and the component. A receiver of the firearm may obtain a control signal from a remote location relative the firearm for relaying to the processor to determine the one of the disabling and the enabling of the firing. The component of the actuating assembly which is interfaced by the implement may be a firing pin, a safety switch or a trigger mechanism. Further, the signal may be global positioning system information or an instruction signal specific to one of the disabling and the enabling.

### BRIEF DESCRIPTION OF THE DRAWINGS

Implementations of various structure and techniques will hereafter be described with reference to the accompanying drawings. It should be understood, however, that these drawings are illustrative and not meant to limit the scope of claimed embodiments.

FIG. 1 is a side view of an embodiment of a global positioning system enabled and disabled firearm.

FIG. 2 is an enlarged partially sectional view of an embodiment of a control system of the firearm of FIG. 1.

FIG. 3 is a schematic representation of an enabling and disabling assembly of the control system of FIG. 2.

FIG. 4 is a schematic representation of remote communicative interfacing of the firearm of FIG. 1 for enabling and/or disabling thereof.

### DETAILED DESCRIPTION

In the following description, numerous details are set forth to provide an understanding of the present disclosure. However, it will be understood by those skilled in the art that the embodiments described may be practiced without these particular details. Further, numerous variations or modifications may be employed which remain contemplated by the embodiments as specifically described.

Embodiments are described with reference to particular semi-automatic firearms. Specifically, an M15 type of firearm is depicted with GPS and/or other remote enabling and disabling assembly features incorporated therein. However, a variety of other firearm types may take advantage of remote enabling and disabling control system features as detailed herein. For example, the firearm may be semi-automatic or automatic. Indeed, even a revolver may take advantage of such remote assembly features. So long as the firearm is outfitted with an implement capable of being remotely directed to enable and disable the firearm appreciable benefit may be realized.

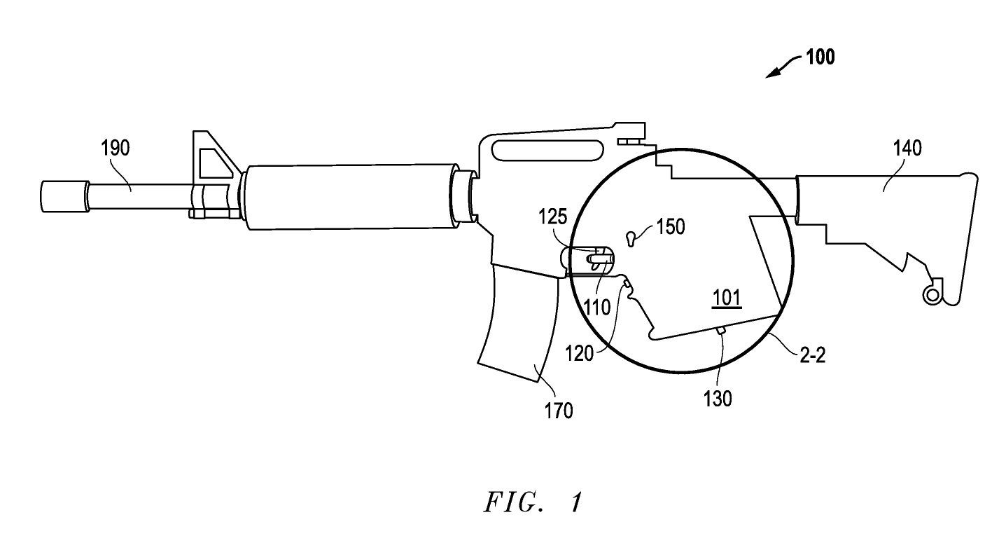

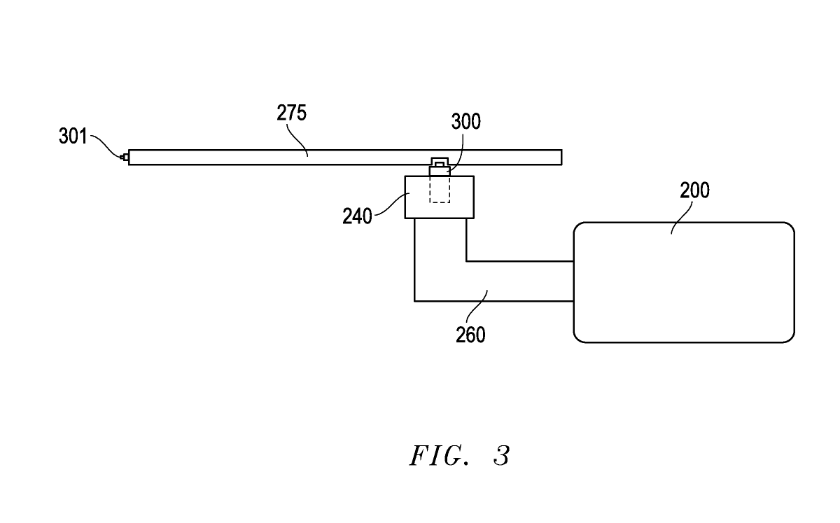

Referring now to FIG. 1, a side view of an embodiment of a global positioning system enabled and disabled firearm 100 is shown. Along these lines, the firearm 100 includes a housing assembly 101 that includes a control system for allowing and effectuating a remote manner of enabling and/or disabling the ability of the firearm 100 to fire a round. For example, as detailed further below with specific reference to FIG. 3, the housing assembly 101 may accommodate an implement 300 that is remotely directed to interface, by disengaging or engaging, an actuating component 275 for respectively enabling or disabling firing of the firearm. As illustrated herein, the actuating component 275 is a firing pin 300 (see FIG. 3). However, alternative actuating components may be immobilized or otherwise disabled so as to render the entire firearm 100 disabled.

Continuing with reference to FIG. 1, the firearm 100 depicted is an M15-type of semi-automatic firearm configuration. However, as indicated above, the firearm 100 may be of other types including fully-automatic or even revolver type of configurations. In the embodiment shown, the only morphological distinction from a conventional M15 in appearance is the presence of an enlarged region, referred to herein as the “housing assembly” 101 as noted above. That is, from the butt 140 at one end to the barrel 190 at the other end, no other substantial distinction from a conventional M15 is apparent. Furthermore, while the housing assembly 101 takes on an appearance of some considerable bulk for sake of accommodating a control system that allows for the remote enabling or disabling of the firearm 100, this is not necessarily required. That is, such system components may be housed within a much smaller and more ergonomic housing assembly 101 or perhaps even distributed throughout the body of a more conventionally shaped M15 or other firearm type. Along these lines, as opposed to being readily accessible by the user, the enabling and disabling system components within the housing assembly 101 (or elsewhere) are not manually accessible by the user. Instead, such components, as well as the housing assembly 101 itself, are integral with the main body of the firearm 100. Thus, as a practical matter, efforts to manually access or adjust these components are likely to be fruitless and result in damaging and permanently disabling the firearm 100.

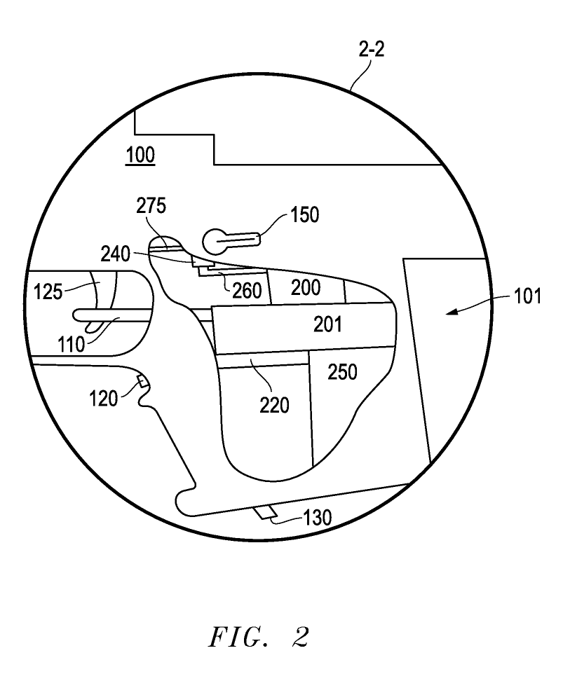

With the integral nature of the housing assembly 101 and internal components in mind, the assembly 101 or other accessible location of the firearm 100 may be outfitted with interfacing ports. For example, in one embodiment, the firearm 100 is equipped with a port for recharging of an internal power source for enabling and disabling or other components of the firearm 100. Alternatively, the battery may be a replaceable feature similar to the magazine 170 noted below, and thus, located physically apart from the more integral components of the housing assembly 101. Further, in addition to electronic connections for sake of battery recharge, the same or another port may be provided for sake of providing database/processor updates. For example, as detailed further below, one component of the assembly 101 may be a control unit 250 with a processor that accounts for information such as location coordinates (see FIG. 2). Thus, updating enabling and disabling parameters relative such coordinates may be achieved through such a port or alternatively in a wireless fashion.

As alluded to above, the firearm 100 may be configured to be enabled for firing based on location coordinates such as GPS (global positioning system coordinates). That is, when the firearm 100 is within certain pre-determined location coordinates, it may be disabled through techniques detailed below whereas when located outside of such locations, the firearm 100 may be enabled for firing.

In addition to location based enabling or disabling of the firearm 100, trigger assistance features may be provided. For example, in an embodiment as shown, where the firearm 100 is of a non-fully automatic variety, a finger extension 110 may engage the trigger 125 to provide a safely controlled form of trigger assistance. The extension 110 may be a wire, small rod or other appropriate device of suitable size, morphology and durability for the task of trigger assistance. Along these lines, an arming switch 130 and a manual actuator 120 in the form of a conventional press-type button may also be provided. Thus, a user may turn on or “arm” the firearm 100 by deflecting or positioning the switch 130 to an armed position. Requiring arming in this manner may help to prevent any accidental firing. Once armed, the user may press the actuator 120 in order to begin reciprocation of the finger extension 110 as detailed in U.S. application Ser. No. 14/658,384. In this way, the user may be provided with controlled trigger assistance. Furthermore, in one embodiment, the trigger 125 may not be pulled except by way of the finger extension 110. In this way an added measure of safety and control may be provided. In fact, in an embodiment where the user is required to first enter a code or provide other identification as a prerequisite to arming or using the firearm 100. Preventing manual firing and requiring firing via the extension 110 in this manner helps ensure that unauthorized users are not able to use the firearm 100.

Continuing with reference to FIG. 1, in the embodiment shown, the firearm 100 includes the noted trigger 125 which may be pulled by the user or the indicated extension 110 for firing a round when the safety switch 150 is in the “off” position as shown. A host of rounds may be supplied to the firearm for such firing by a magazine 170 which may be replaced with a new magazine of rounds as needed. As indicated, the safety switch 150 is shown in a vertical position which conventionally translates to being “off” and allowing for the noted trigger pull and firing. Alternatively, in advance of firing, the safety switch 150 may be rotatably pulled back to an “on” position so as to prevent firing of the firearm. However, as detailed further below, components within the assembly housing 101 may be provided that automatically and/or remotely enable or disable the firearm 100 irrespective of the user determined position of the switch 150.

Referring now to FIG. 2, an enlarged partially sectional view of an embodiment of a firearm control system taken from 2-2 of FIG. 1 is shown. As indicated above, the control system may be utilized to provide for automatic enabling or disabling of the firearm 100 depending on GPS location coordinates thereof. However, as detailed further below, in other embodiments, factors apart from location coordinates may be utilized for automatically enabling or disabling of the firearm 100.

In the depiction of FIG. 2, the safety switch 150 is shown rotated to an “on” position. Thus, whether the trigger 125 is to be pulled directly or indirectly through the extension 110, the firearm 100 is actually disabled. Specifically, rotation of the safety switch 150 as shown results in engagement and immobilization of an internal component such as a firing pin 275. Therefore, regardless of the efforts to pull the trigger 125, the firearm 100 is disabled. However, disabling the firearm through the safety switch is overcome merely by the user's ability to manually rotate the switch 150 back to the “off” position (e.g. as depicted in FIG. 1).

Continuing with reference to FIG. 2, enabling and disabling of the firearm 100 may also be governed by means that are outside of the user's control. That is, as described above, a manually inaccessible control system within the housing 101 may coordinate different types of information and effectively enable or disable the firearm 100 irrespective of the user's efforts. Specifically, even with the safety switch 150 in the “off” position, the firearm 100 may be disabled. Further, while the control system may be referenced herein as enabling the firearm 100, this does not preclude the user from manually disabling the firearm 100 via the switch 150, a trigger lock or other means. That is, as used herein, reference to the control system as enabling the firearm 100 is only meant to refer to the fact that the firearm 100 may be enabled to the extent that the user so desires whereas disabling of the firearm 100 removes manual enabling from the user's control.

With specific reference to the underlying system components visible in FIG. 2, an implement motor 240 is shown. The motor 240 may be a suitably sized solenoid that is structurally and communicatively supported by an arm 260 running to a receiver 200 of the system. The receiver 200 in turn is configured to provide location coordinate or other information to a processor at a control unit 250, or alternatively, to a dedicated processor coupled to the receiver 200. Regardless, based on this information, a non-user based determination of whether to enable or disable the firearm 100 may be made and carried out by the implement motor 240. Specifically, the motor 240 may govern the disengagement or engagement of an implement 300 with the firing pin 275 as shown in FIG. 3. Disengagement would result in a condition of enabling the firearm 100 (again, to the extent desired by the user) whereas engagement would result in disabling of the firearm (irrespective of the user's desires).

Continuing with reference to FIG. 2, as alluded to above, the processor in communication with the receiver 200 may utilize GPS information therefrom to determine whether or not to direct enabling or disabling of the firearm 100 through the implement motor 240 as described. For example, the firearm 100 may be generally enabled unless and until information obtained by the receiver 200 corresponds to a predetermined location for disabling of the firearm 100. These “forbidden” locations may include areas near and within school zones, banks, shopping malls, parks, roadways and any location where firearm discharge would be illegal.

The processor of the system may analyze GPS location information from the receiver 200 against pre-stored forbidden location information so as to instruct disabling of the firearm 100 when a match presents between the obtained receiver information and the pre-stored forbidden location information. Further, as alluded to above, the pre-stored forbidden location information may be updated on an ongoing basis either wirelessly through the receiver 200 or via USB or other suitable connection to an updating source.

Continuing with reference to FIG. 2, the housing assembly 101 also accommodates components for assisting pulling of the trigger 125 in a controlled manner as detailed in U.S. application Ser. No. 14/658,384. Specifically, the noted control unit 250 may be utilized to direct a solenoid or other suitable motor 201 to power the extension 110 for pulling the trigger 125 at a repeating given rate for firing of individual rounds (with one round fired per each pull of the trigger 125). Thus, enhanced safety, accuracy and control over the firearm 100 may be attained as the user simply presses the actuator 120. In the embodiment shown, the actuator 120 is coupled to the control unit 250 through a structural relay 220 in order to direct the noted controlled firing through the unit 250. However, in other configurations, the actuator 120 may be in more direct contact with the control unit 250 for actuation.

In addition to enhanced safety via the described trigger assistance, the improved control may also contribute to reducing the amount of rounds spent over a period of time. That is, as opposed to a rapid, less controlled firing of the firearm 100, a controlled rate of fire may save rounds. Furthermore, with the inclusion of a receiver 200 as part of the overall system, the number of rounds spent may be tracked remotely. That is, in one embodiment, the receiver 200 may double as a transmitter or overall transceiver assembly. So, for example, in a military or police environment, a central command may be provided with real-time information regarding the amount of rounds spent, by which firearms 100 and even where these firearms 100 are located. Thus, without even requiring the military personnel user to place a re-order for ammunition, logistics for re-supplying the battlefield may already be underway as directed by central command.

Of course, in other embodiments, the central command may not be of a policing or military control type of situation. For example, the central command may constitute a bank or individual user possessing a mobile application capable of receiving the transmitted firearm information. Even though lacking an actual policing or military type of authority, such a “command” user may manually or automatically pass along relevant firearm information to appropriate policing or military authorities or merely take personal evasive action as needed.

Referring now to FIG. 3, a schematic representation of an enabling and disabling assembly of the control system of FIG. 2 is shown. In this view, the interfacing between the implement 300 and the actuating component/firing pin 275 is apparent. That is, depending on the behavior of the implement motor 240, the implement 300 may move up to ⅛^{th} of an inch or so to engage and immobilize the firing pin 275 and thereby disable the firearm 100. That is, without the ability of the firing pin head 301 to strike forward on a round of ammunition, the firearm 100 is left unable to fire. However, depending on commands from the processor at the control unit 250, receiver 200 or elsewhere, the motor 240 may be instructed to remain disengaged from the firing pin 275 leaving the firearm 100 enabled.

In one embodiment, the motor 240 may default to engage the implement 300 with the firing pin 175 so as to disable the firearm 100 whenever no signal or power is detected in the system. However, when powered and equipped with a functional receiver 200, disabling of the firearm 100 may generally be dictated by location information obtained by the receiver 200 as detailed above. Alternatively though, in an embodiment where the receiver 200 or the system is equipped with transmitting capability as described further above, the firearm 100 may be disabled based on information other than, or in addition to, location information.

In one embodiment, a transmitter of the system may be utilized to broadcast identification information regarding the firearm 100 to a central command as noted above. However, in this embodiment, such electronic identification may be used for firearm specific enabling and disabling via remote command. That is, as opposed to location specific enabling and disabling of the firearm 100, a central command in communication with the receiver 200 and transmitter of the identified firearm 100 may enable or disable the firearm 100. So, for example, all firearms identified as suspect due to a particular registered owner, those reported as stolen, those recently detected as firing in a given geographic area or a host of other factors, may be disabled by the appropriate policing central command.

In another embodiment, the firearm 100 may be equipped with a default function such that the motor 240 and implement 300 disable the firearm 100 unless an authorization signal is obtained by the receiver 200. In this embodiment, jurisdictions that seek to disable all firearms in a given region for example, when a gunman is on the loose or mass shooting is underway may automatically do so. Further, two-way communications for determining enabling and disabling of firearms may have advantages beyond policing. For example, in military circumstances, it may be desirable to disable all military personnel firearms in a given area when there is a concern that the arms have fallen into the hands of enemy combatants. Thus, detecting and disabling these firearms may be of significant benefit.

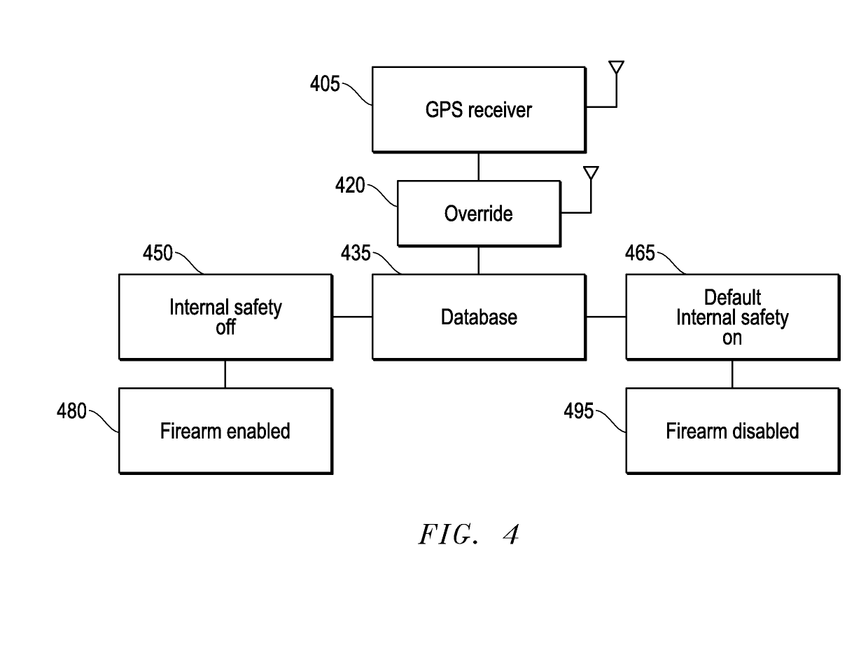

Referring now to FIG. 4, a schematic representation of one embodiment of remote communicative interfacing of the firearm of FIG. 1 is shown for enabling and/or disabling thereof. As indicated at 405 and detailed above, the firearm may be equipped with a receiver that obtains GPS location information. This GPS information may be cross-checked against stored database location information as indicated at 435. Depending on the results of this cross-check, the internal safety may be turned off as indicated at 450. For example, where the cross-check indicates that the firearm is in a location that is not classified as “forbidden”, a motor and restricting implement within the firearm may disengage from a firing pin and allow enabling thereof. Thus, the firearm may shoot (see 480). On the other hand, where the cross-check reveals that the firearm is in a location that is forbidden, the internal safety of an engaged implement may be “on” (see 465) such that the firearm is disabled as noted at 495.

Continuing with reference to FIG. 4 and as described above, the “internal safety” of engagement between the restricting implement and an actuating component such as a firing pin may be on as a matter of default (see 465). More specifically, the firearm may be disabled unless location information is provided that cross-checks with the firearm being outside of a forbidden location. Thus, in circumstances of power and/or GPS or receiver failure, the firearm would be automatically disabled. Furthermore, as indicated at 420 even in circumstances where the firearm is not identified as being in a forbidden location, an override may take place for disabling the firearm, regardless. For example, as detailed above, with two way communications available, a firearm may be disabled due to theft or a variety of real-time military or policing circumstances even though the identified location is not necessarily predetermined as “forbidden”.

Embodiments described hereinabove include techniques that allow for gun monitoring or tracking and control in a practical and effective manner, perhaps even in advance of illegal or other dangerous unauthorized activity has taken place. Once more, this level of firearm safety may be achieved through the system and techniques detailed herein in manners that do not require confiscation or other similarly extreme measures.

The preceding description has been presented with reference to presently preferred embodiments. Persons skilled in the art and technology to which these embodiments pertain will appreciate that alterations and changes in the described structures and methods of operation may be practiced without meaningfully departing from the principle, and scope of these embodiments. For example, while the firearm control system is detailed hereinabove as having a GPS/receiver and other components entirely housed within the firearm, this is not necessarily required. Indeed, a GPS receiver and other communicative and even data storage devices of the system may be handheld or suitably sized for carrying by the user apart from the firearm. Thus, size and weight limitations of the firearm itself may be less affected by the use of the control system. Furthermore, the foregoing description should not be read as pertaining only to the precise structures described and shown in the accompanying drawings, but rather should be read as consistent with and as support for the following claims, which are to have their fullest and fairest scope.

I claim:

1. A firearm control system of a firearm for enabling and disabling the firearm, the control system comprising:
an actuating component for assisting in firing of a round from the firearm;
an implement for interfacing the actuating component;
a motor coupled to the implement to effect disengaging thereof with the actuating component for the enabling and to effect engaging thereof with the actuating component for the disabling;
a receiver for obtaining an information signal from a remote location relative the firearm; and
a processor coupled to the receiver for analyzing the information signal and directing the motor to effect the disengaging and the engaging based on the analyzing.

2. The firearm control system of claim 1 wherein the information signal is one of global positioning system information and an instruction signal specific for one of the disabling and the enabling of the firearm.

3. The firearm control system of claim 2 wherein the processor includes a database of location coordinates for comparison against the global positioning system information for the analyzing.

4. The firearm control system of claim 1 further comprising a transmitter for sending out firearm information from the firearm.

5. The firearm control system of claim 4 wherein the sending out of the firearm information is to the remote location and the firearm information is firearm identification information.

6. The firearm control system of claim 1 wherein the motor is a solenoid for moving the implement less than about ⅛ of an inch for the disengaging and engaging of the actuating component.

7. The firearm control system of claim 1 wherein the actuating component is one of a firing pin, a safety switch and a trigger mechanism.

8. A firearm comprising:
a firearm control system for enabling and disabling the firearm based on analysis of an information signal from a remote location;
a finger extension for engagement with a trigger of the firearm;
a motor coupled to the extension for reciprocatingly driving the extension to pull the trigger for firing of the firearm; and
a processor coupled to the motor for directing a controlled rate of the firing.

9. The firearm of claim 8 wherein the firearm control system is manually inaccessible.

10. The firearm of claim 8 wherein the firearm control system comprises one of a receiver and a processor housed outside of the firearm.

11. The firearm of claim 8 further comprising an interfacing port to support one of updating a database of the firearm control system and recharging a power source.

12. The firearm of claim 8 further comprising a removable power source.

13. A method comprising:
using a motor to effect one of disengaging and engaging of an implement with an actuating component of a firearm for one of enabling and disabling firing of the firearm;
sending an information signal from a remote location to a receiver for the firearm;
analyzing the information signal with a processor for the firearm; and
directing the one of the enabling and the disabling based on results of the analyzing

14. The method of claim 13 wherein the information signal provides global positioning system information, the analyzing comprising comparing a database of pre-stored forbidden location information at the processor with the global positioning system information, the enabling corresponding to a lack of a match between the forbidden location information and the global positioning information, the disabling corresponding to a match between the forbidden location information and the global positioning system information.

15. The method of claim 14 wherein the forbidden location information is information corresponding to one of a school zone, a bank, a shopping mall, a park, a roadway and a location where firearm discharge is illegal.

16. The method of claim 14 further comprising updating the database of forbidden location information.

17. The method of claim 13 further comprising transmitting real-time information about the firearm to a remote command location.

18. The method of claim 17 wherein the real-time information relates to one of identification of the firearm, location of the firearm, a firing of the firearm, a rate of firing of the firearm and total rounds spent by firing of the firearm.

19. The method of claim 17 further comprising overriding the one of the directing of the enabling and the disabling with an instruction signal from the command location to the receiver for the firearm, the overriding based on the real-time information.

20. The method of claim 13 wherein the motor is configured to effect the disabling of the firearm by default in absence of one of a power supply and the directing of the enabling.
